(19) United States
(12) Patent Application Publication
(10) Pub. No.: US 2005/0109974 A1
(43) Pub. Date: May 26, 2005

(54) Valve for a non-refillable pressurized container

(76) Inventors: Joao Carlos V. Antunes Guimaraes, Braga (PT); Tiago Oliveira, Porto (PT)

Correspondence Address: EDWARDS & ANGELL, LLP, P.O. BOX 55874, BOSTON, MA, 02205, US

(21) Appl. No.: 10/993,912

(22) Filed: Nov. 19, 2004

Related U.S. Application Data
(60) Provisional application No. 60/523,950, filed on Nov. 21, 2003.

(51) Int. Cl. F16K 1/00

(52) U.S. Cl. 251/357; 251/334

(57) ABSTRACT

A valve for a pressurized container is described. The valve housing has a central bore, a port in said housing to facilitate connection of a nozzle thereto, and a t-stem having a lower end with an opening. A two part poppit is positioned in the t-stem for sealing the valve. The has an elastomeric valve seat portion and a support portion for the valve seat. The support portion includes a shaft that is received in an opening of the lower end of the t-stem.

### REFERENCE TO RELATED APPLICATIONS

This application claims priority from U.S. application Ser. No. 60/523,950 filed Nov. 21, 2003.

### BACKGROUND OF THE INVENTION

1. Field of the Invention

The invention generally relates to valves for pressurized tanks or other pressurized containers, e.g., pressurized gas bottles. More particularly, the invention relates to valves for pressurized containers which are commercially characterized as being “non-refillable” or “no-return” containers and which, for reasons of safety and otherwise, are not intended for re-use after their initial contents have been emptied. Valves for such containers are also often referred to in the art as “single use” valves for pressurized containers.

2. Background Of The Invention

Pressure tanks or other pressure containers are usually filled under carefully controlled conditions at a charging station and then distributed to other places for use. When empty it is intended that the containers be returned to the charging center for appropriate reuse or destruction in the case of single use containers. Unfortunately, the attractive economies of refilling containers at points of use or otherwise repressurizing them under less than carefully supervised conditions has resulted in the introduction of impurities or inferior refills and, more seriously, in injurious explosions. The reuse of pressure containers is highly objectionable for many reasons which relate to safety.

So-called “non-refillable valves” are well known in the prior art. Specific examples of known valves include valves of the type described in U.S. Pat. No. 4,543,980, to van der Sanden, issued Oct. 1, 1985; valves of the type described in U.S. Pat. No. 4,573,611, to O'Connor, issued Mar. 4, 1986, and the various prior art valves described in the aforementioned patents.

Non-refillable valves desirably fill the following requirements: (a) the need for a dual purpose manufacturing process that uses a single basic valve design to enable both refillable and non-refillable valves to be manufactured using essentially the same parts list, machine tools, etc.; instead of the present practice of having to execute dedicated manufacturing process for producing refillable versus non-refillable type valves (because of differing housing types that are used, different components required for valve operation, etc.); (b) the need for a valve design (both refillable and non-refillable) that utilizes a mechanically operated primary sealing mechanism (as opposed to valve designs that utilize a pressure differential to open the primary sealing mechanism) to insure seal quality while solving the other problems with known valves indicated hereinabove; (c) the need for a valve design that prevents rotation of the primary sealing mechanism in the valve housing to minimize wear, extend valve life and further improve seal quality; (d) the need for a valve design in which the primary sealing mechanism and means for controlling the opening and closing of the valve are optionally made from discrete components formed from different materials to enable the sealing mechanism to be chemically compatible with the fluid contents of the container even when the controlling mechanism (means for controlling the opening and closing of the valve) is not; and (e) the need for a valve design, solving all of the aforementioned problems and meeting the aforestated needs, which is relatively simple and inexpensive, which will allow normal filling of the pressure container under proper conditions, adequate sealing of the pressure during nonuse, selective discharge of the pressure container and, in the case of the non-refillable valves contemplated by the invention, provide effective protection and prevention against improper and unauthorized filling of the container.

A new standard for disposable cylinders was published in Europe, EN 12205. One of the requirements of this standard was that the valve used in these cylinders should conform to EN ISO 13340. With certain present commercial valves, after filling the cylinder for the first time, and having shut the valve once, when we tried to refill the cylinder with helium, the filling rate was greater than 3 cm² per hour, which does not comply with the new standard specification.

Thus, it can be appreciated that it remains desirable to have new valve designs that provide the needs discussed hereinabove and yet remain relatively simple and inexpensive to produce.

### SUMMARY OF THE INVENTION

The present invention provides a valve design that utilizes a poppit that provides a seal meeting the new EN ISO 13340 standard. In accord with the present invention, a valve for a pressurized container comprises a valve housing having a central bore for communicating with the container; a port in said housing to facilitate connection of a nozzle thereto; a t-stem having a lower end with an opening; and a poppit comprising a valve seat providing the primary valve seal when the valve is closed. The poppit comprises a valve seat and a support for the valve seat, the support having a shaft that is received in the opening of the lower end of the t-stem. The valve seat is made from an elastomeric material, which can be a natural or synthetic rubber.

In one embodiment of the invention, a valve for a pressurized container comprises a unidirectional stepped valve housing, wherein said housing comprises a central bore that includes an upper portion, lower portion and a middle portion located therebetween, wherein said lower portion is narrower than said middle portion which in turn is narrower than said upper portion; a port in the middle portion of said housing to facilitate connection of a nozzle thereto; a t-stem having a lower end with a key-way, the lower end further having in conjunction with the key-way a cavity of a predetermined geometric shape; and a valve seat providing the primary valve seal when the valve is closed, wherein the valve seat has an upper portion and a lower portion, the lower portion being structured and arranged to provide the primary valve seal in cooperation with the valve housing, the upper portion having a geometry corresponding to the predetermined geometric shape for engaging with the t-stem to provide a locked assembly; the t-stem and valve seat being located in the housing and cooperating to position the valve seat for the primary valve seal. A non-refillable valve in accord with the present invention further comprises a blocking element in the lower portion of said central bore.

These and other features of the present invention and the manner of obtaining them will become apparent to those skilled in the art, and the invention itself will be better understood by reference to the following detailed description read in conjunction with the accompanying Drawings.

### BRIEF DESCRIPTION OF THE DRAWINGS

FIG. 1 is an elevation view, partially in cross-section, of a non-refillable valve in accord with one embodiment of the present invention.

FIG. 2 is an elevation view of the poppit of the valve shown in FIG. 1.

FIG. 3 is an elevation view, partially in cross-section, of the poppit shown in FIG. 2.

FIG. 4 is an elevation view, partially in cross-section, of the poppit turned 90° from the view shown in FIG. 3.

FIG. 5 is a partial elevation view of the support portion of the poppit of FIG. 2.

FIG. 6 is a view looking up at the support portion in FIG. 5.

FIG. 7 is an elevational cross section view of the valve seat portion of the poppit shown in FIG. 3.

FIG. 8 is a plan view of the valve seat portion of the poppit shown in FIG. 7.

FIG. 9 is an elevation view, partly in cross-section of an alternative embodiment of a stem useful in valves in accord with the present invention.

### DETAILED DESCRIPTION OF THE INVENTION AND PREFERRED EMBODIMENT

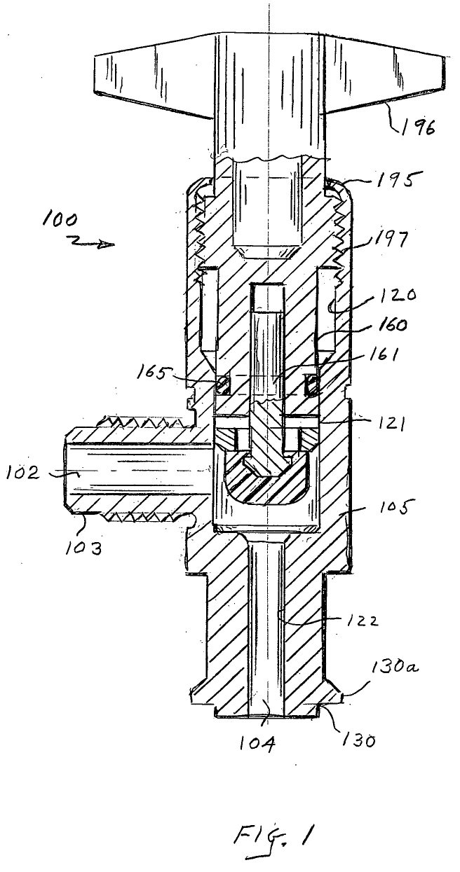

A non-refillable valve of the type contemplated by one aspect of the invention will be described with reference to the figures. FIG. 1 is an elevational or longitudinal view of a non-refillable valve 100 for a container (not shown). The valve 100 permits the initial charging of a container with fluid from a fluid source (not shown) that may be introduced into the container via, for example, passageway (port) 102 through nozzle 103. Thus, in use, valve passageway 102 is in fluid communication with the interior portion of container via central bore 104 in valve housing 105.

In this embodiment, central bore 104 in valve housing 105 has three distinct portions: upper bore portion 120, middle bore portion 121 and lower bore portion 122. In accord with a preferred embodiment of the invention, valve housing 105 is a unidirectional stepped valve housing (i.e., a valve housing that includes a central bore having two or more stepped portions each radially increasing (or conversely decreasing) as the bore is traversed in a given direction).

Traversing the valve from top to bottom, the radius of the bore in the upper valve portion 120 can be seen to be greater than the radius in middle valve portion 121; and the radius in middle valve portion 121 can in be seen to be greater than the radius in lower valve portion 122. This design can be advantageous for valve manufacturing purposes.

Non-refillable valve 100 can be attached to a cylinder expressly intended for a one fill opportunity. The attachment is typically performed by welding valve housing 105 to the container in the area marked 130 and 130a in FIG. 1.

Non-refillable valve 100 has the following main components: t-stem 160 for controlling the opening and closing of the valve; a two piece poppit 161 including a support portion 163 and a valve seat portion 164; unidirectional stepped valve housing 105 which encloses all valve components; sealing means (such as o-ring seal 165); and nozzle (or port) 103 for filling and using the container. For extra sealing in the valve housing, a second o-ring can be used, one in each groove 166, as shown in the t-stem 160-1 illustrated in FIG. 9.

The t-stem 160, 160-1 is used to control the opening and closing of the non-refillable valve.

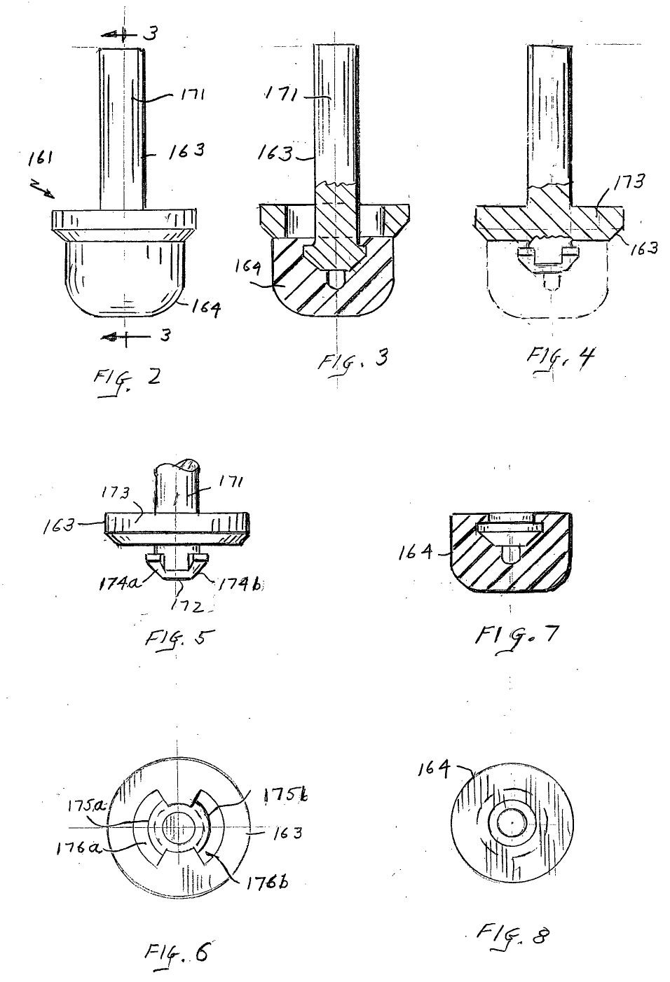

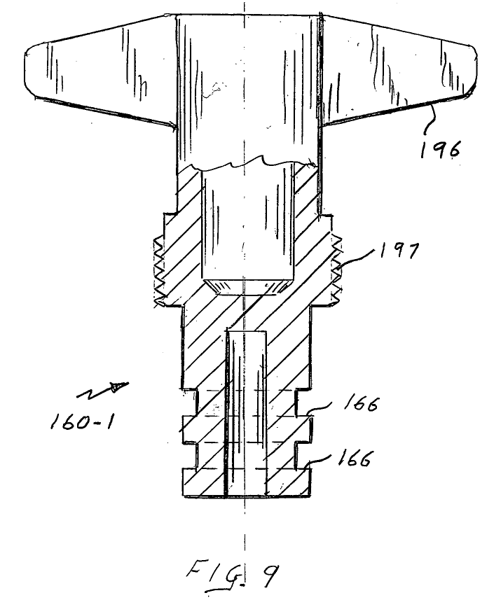

The two piece poppit 161 is further illustrated in FIGS. 2-8. The valve seat portion 164 is designed to make the primary valve seal when valve 100 is closed. In accord with the present invention, as shown in more detail in FIGS. 3-7, the valve seat portion 164 forms a locking engagement with the support portion 163. The support portion comprises a shaft 171 for insertion into t-stem 160 when the two components are assembled. As such, the t-stem 160 has an internal opening, or bore hole 161, in the lower end for receiving the shaft 171 of the poppit.

Valve seat 164 has an interior geometry that cooperates with the end 172 of the support portion opposite the shaft 171. Near the end 172, the support portion has an integral disk 173 providing a platform for the valve seat 164. The end 172 is tapered having an angled surface 174a, 174b which extends beyond the diameter of the shat 171 to form a cap. The angled surface forms an arcuate section 175a, 175b on opposite sides of the shaft. Arcuate openings 176a, 176b are provided in the disk 173 to aid in molding the support portion 163 as an integral unit. The valve seat portion 164 is preferably symmetrical about its longitudinal axis.

Those skilled in the art will readily appreciate that alternative geometries can be employed for the components of the poppit. The depicted support portion and valve seat portion are not intended to limit the scope of the invention, but rather to illustrate a suitable shapes for effecting the primary valve seal and effecting a locking engagement.

In the embodiment of the invention illustrated in FIG. 1, all valve components are held inside valve housing 105 by a permanent swage to the end of valve housing 105 (shown at 195 in FIG. 1). The valve is opened and closed by rotating the handle 196 of t-stem 160. As illustrate, t-stem 160 rotation is translated to an axial motion within the valve housing 105 via screw threads 197.

Furthermore, according to one embodiment of the invention, valve seat 164 and support portion 163 are attached by snap-fit engagement illustrated in FIGS. 3-7. Snap-fit coupling of the components is accomplished by corresponding locking geometries of the end of the support portion and the internal opening of the valve seat. Other geometries for accomplishing the desired result can be readily designed by those skilled practitioners of the art.

The valve seat portion is made of an elastomeric material in order to provide a suitable seal meeting the requirements of EN ISO 13340. The elastomeric material can be either a natural or synthetic rubber. The material should be selected depending on the intended contents of the container on which the valve is used. A preferred elastomeric material is thermoplastic elastomer such as a styrene butadiene block copolymer, particularly modified with polypropylene, e.g. SEBS/SEPS base modified with PP where SEBS is styrene butadiene block copolymer with hydrogenated polybutadiene, SEPS is styrene butadiene block copolymer with hydrogenated polyisoprene, and PP is polypropylene. Prederably, the hardness of the elastomeric material is between about 50 to about 90 on the Shore A scale, more preferably about 60 to about 80 Shore A. In one embodiemnt for storing compressed gas at −50° C., a hardness of 60 was found to be useful.

A suitable material for a helium container is Multiflex™ G 60 A 21 BT Z3519N0104.

The supporting portion of the poppit can be any suitable material. Preferably the support portion is made of a plastic resin. A suitable material for the support portion is Zytel™ 70G33HS1L BK031R.

The non refillable valve is shipped with the valve stem in the factory pre-set full open position. The free floating nose cone is compressed and retained in the narrow upper barrel of the valve body. In this position, the valve is fully open and the evacuation and filling process is carried out in the normal manner.

In use, after the initial filling of a container having the valve of the present invention is completed, the valve is closed. Once positioned, it preferably is impossible to force the valve seat back into the factory preset open position. When the t-stem is fully closed, the nose-cone of the valve seat is forced down against the valve housing and the valve is closed for storage and transportation to the field. The valve preferably is closed to a torque value of 35 inch-pounds (3.9 N/Mtr.) using manual or automatic drivers which incorporate an automatic torque limiting device.

To use the contents of the container, the valve is manually opened in the normal manner. Because external pressure in the system being serviced is lower than the internal pressure of the cylinder, the pressure differential preferably forces the free-floating poppit off the valve housing to open the lower portion of the bore to the container and contents are discharged at the full flow rate, in the normal manner. When the desired amount of the contents has been discharged, the valve is manually closed and cylinder contents are protected until the next use. The cylinder is used in the normal way until its contents have been fully discharged.

At any time during use or after the contents have been discharged, should the cylinder be accidentally or deliberately connected to a pressure source higher than the internal pressure of the cylinder and the valve manually opened, the pressure differential preferably will instantly force the free-floating poppit back onto the valve housing to prevent the introduction of materials into the cylinder. In preferred embodiments, this automatic valve closure occurs regardless of the cylinder position.

The invention has been described in detail including the preferred embodiments. However, it should be appreciated that those skilled in the art may make modifications and variations within the scope of the present invention in light of the above teachings. Therefore, it is understood that the claims appended hereto are intended to cover all such modifications and variations which fall within the true scope and spirit of the invention.

1. A valve for a pressurized container, the valve comprising:
a valve housing having a central bore;
a port in said housing to facilitate connection of a nozzle thereto;
a t-stem having a lower end with an opening; and
a two part poppit;
wherein the poppit comprises an elastomeric valve seat portion and a support portion for the valve seat, the support portion having a shaft that is received in the opening of the lower end of the t-stem.

2. The valve of claim 1, wherein the valve seat comprises an elastomeric material, which can be a natural or synthetic rubber.

3. The valve of claim 2, wherein the elastomeric material has a hardness in the range of about 50 to about 90 Shore A.

4. The valve of claim 2, wherein the elastomeric material comprises a styrene butadiene block copolymer.

5. The valve of claim 4, wherein the styrene butadiene block copolymer comprises hydrogenated polybutadiene.

6. The valve of claim 4, wherein the styrene butadiene block copolymer comprises hydrogenated polyisoprene.

7. The valve of claim 4, wherein the elastomeric material further comprises polypropylene.

8. A two-part poppit for use in a valve for a pressurized container, the poppit comprising an elastomeric valve seat portion and a support portion for the valve seat, the support portion having a shaft that is received in the opening of the lower end of the t-stem.

9. The two-part poppit of claim 8, wherein the valve seat comprises an elastomeric material, which can be a natural or synthetic rubber.

10. The two-part poppit of claim 9, wherein the elastomeric material has a hardness in the range of about 50 to about 90 Shore A.

11. The two-part poppit of claim 9, wherein the elastomeric material comprises a styrene butadiene block copolymer.

12. The two-part poppit of claim 11, wherein the styrene butadiene block copolymer comprises hydrogenated polybutadiene.

13. The two-part poppit of claim 11, wherein the styrene butadiene block copolymer comprises hydrogenated polyisoprene.

14. The two-part poppit of claim 9, wherein the elastomeric material further comprises polypropylene.

15. A pressurized container comprising a valve, the valve comprising: a valve housing having a central bore; a port in said housing to facilitate connection of a nozzle thereto; a t-stem having a lower end with an opening; and a two part poppit; wherein the poppit comprises an elastomeric valve seat portion and a support portion for the valve seat, the support portion having a shaft that is received in the opening of the lower end of the t-stem.

16. The pressurized container of claim 15, wherein the valve seat comprises an elastomeric material, which can be a natural or synthetic rubber.

17. The pressurized container of claim 16, wherein the elastomeric material has a hardness in the range of about 50 to about 90 Shore A.

18. The pressurized container of claim 16, wherein the elastomeric material comprises a styrene butadiene block copolymer.

19. The pressurized container of claim 18, wherein the styrene butadiene block copolymer comprises hydrogenated polybutadiene.

20. The pressurized container of claim 18, wherein the styrene butadiene block copolymer comprises hydrogenated polyisoprene.

21. The pressurized container of claim 18, wherein the elastomeric material further comprises polypropylene.
